(19) United States
(12) Patent Application Publication
(10) Pub. No.: US 2007/0032119 A1
(43) Pub. Date: Feb. 8, 2007

(54) Fixing device of a communication socket

(76) Inventor: Sheo-Chieh Ting, Banchiau City (TW)

Correspondence Address: Troxell Law Office Pllc, Suite 1404, 5205 Leesburg Pike, Falls Church, VA, 22041, US

(21) Appl. No.: 11/196,404

(22) Filed: Aug. 4, 2005

(51) Int. Cl. H01R 13/625

(52) U.S. Cl. 439/344

(57) ABSTRACT

A fixing device of a communication socket is composed of a seat, which is provided with a conduction terminal, and upper and lower casings which can enclose the aforementioned seat and form left and right slots with the seat. Stopping pieces are installed in the slots and are extended to form flexible holding members to provide a clipping force to the slots, thereby assuring a stable connection between a signal plug and the socket to achieve a best transmission conduction rate.

### BACKGROUND OF THE INVENTION

(a) Field of the Invention

The present invention relates to a network connector, and more particularly to an improved connection socket for a communication device for assuring a clear and stable signal in transmission and contact.

(b) Description of the Prior Art

A communication socket is primarily used in signal transmission of a high frequency network, and an electric wire bundle used for transmitting signal is made by twisting a plurality of reinforced fiber and other high conduction material, and is enclosed by an insulation layer. In order to enhance signal transmitted and to avoid an attenuation of signal in transmission by interference or distance, transmission lines in the electric wire bundle are twisted by pairs, so as to enhance transmission and to eliminate a cross talk of signal transmitted by each transmission line.

However, as a signal plug is connected with its socket only by latching a latch member on the signal plug into the socket, and a signal contact between the two is primarily via a conduction by a conduction material of a transmission line and a conduction terminal in the socket, if there is still a gap after connecting the signal plug with the socket, which causes an inaccurate contact between the two, it will severely affect a transmission conduction rate.

In addition, a signal socket for providing a connection to two signal transmission lines is needed for a communication device due to a system exchange or an insufficient length of the signal transmission line. However, the existing signal socket for providing the connection to two signal transmission lines is constituted by two socket connectors and a seat for connecting the two connectors. Although this kind of structure can serve as a basic connection, a manufacturing cost is increased due to its large size, and a transmission quality is greatly attenuated due to a long transmitting distance between the signals.

### SUMMARY OF THE INVENTION

The primary function of the present invention is to enable a communication equipment to achieve a best signal transmission conduction rate in transmitting signal, and to decrease a signal attenuation caused by forwarding, thereby avoiding a signal cross talk transmitted by each transmission line.

Accordingly, the primary object of the present invention is to provide a fixing device of a communication socket wherein a stopping piece is installed in a slot to provide a clipping force to the slot, thereby assuring a stable connection between a signal plug and the socket.

Another object of the present invention is to provide a fixing device of a communication socket wherein two sides of the socket are provided with a slot for connecting a signal plug respectively, and an electric signal of the two slots is transmitted through a conduction terminal.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of compartments of the present invention.

FIG. 2 shows a perspective view upon assembling the compartments of the present invention.

FIG. 3 shows a schematic view of an implementation of the present invention.

FIG. 4 shows a cutaway view of an implementation of the present invention.

### DETAILED DESCRIPTION OF THE PREFERRED EMBODIMENTS

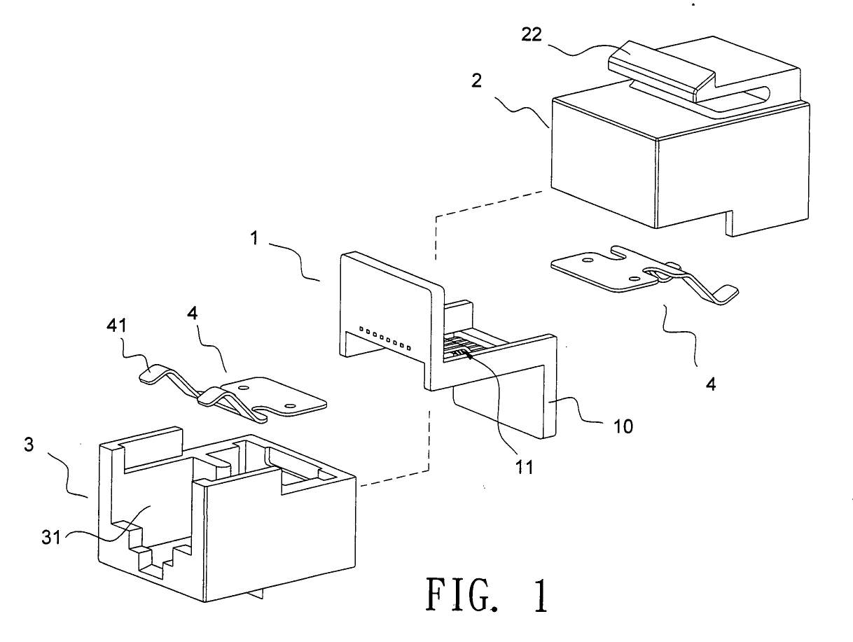

Referring to FIG. 1 and other drawings, the present invention comprises primarily a seat 1, an upper casing 2, a lower casing 3, and a stopping piece 4, wherein the seat 1 is made by an insulation material, with two ends of a main body of the seat 1 being extended upward and downward to constitute a receiving member 10, and the main body of the seat 1 is provided with a conduction terminal 11 which constitutes a corresponding flexible free state by extending from a top end to a lower end of the main body of the seat 1. The upper and lower casings 2, 3 are a frame respectively, and can be connected in opposite to each other to constitute a hollow holding slot whose two sides are provided with slots 21, 31 for installing signal plugs 5, and hooks 22, 32, respectively. The stopping pieces 4 are extended outward from a main body to constitute holding members 41, and are installed in the slots 21, 31 of the upper and lower casings 2, 3 to provide a clipping force to the slots 21, 31.

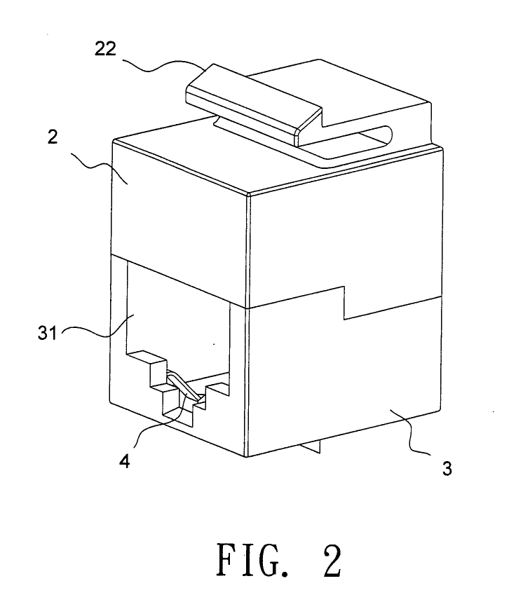

When assembling, the conduction terminal 11 is first emplaced on the seat 1, and the stopping pieces 4 are installed in the upper casing 2 and the lower casing 3, respectively, whereas the holding members 41 on the stopping pieces 4 are just extended to the slots 21, 31 of the upper and lower casings 2, 3. Next, the aforementioned upper and lower casings 2, 3 are connected to the receiving member 10 of the seat 1 respectively, so as to encase the seat 1 in the upper and lower casings 2, 3, thereby accomplishing the assembling (as shown in FIG. 2).

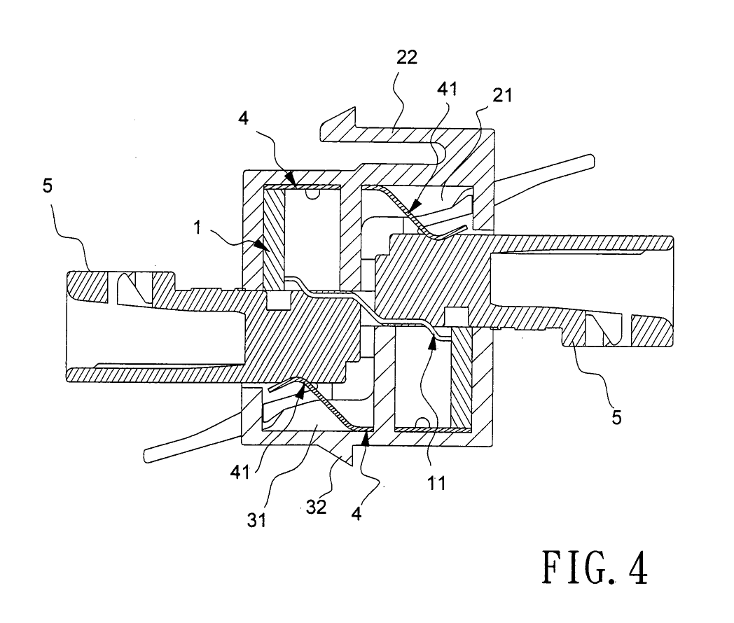

Upon inserting a signal plug 5, as the holding member 41 on the stopping piece 4 provides a proper elasticity, to provide a clipping force to the slots 21, 31, so as to enable a more stable connection between the signal plug 5 and the communication socket without easily shaking (as shown in FIG. 4), thereby achieving a best transmission conduction rate of signal.

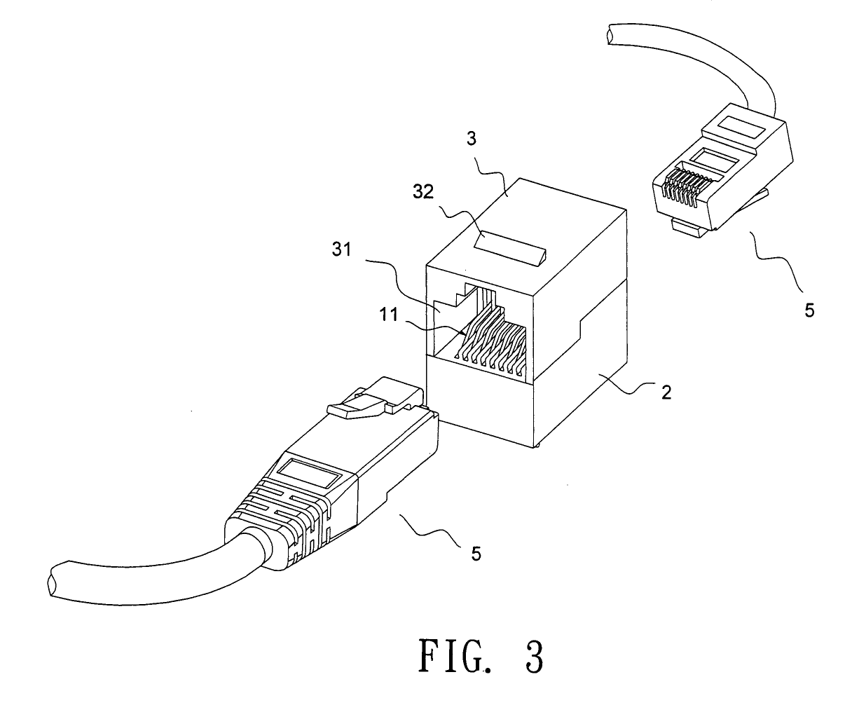

Moreover, as the slots 21, 31 at the left and right sides of the upper and lower casings 2, 3 can be directly formed when assembling the upper and lower casings 2, 3 with the seat 1, so as to provide a socket connector (as shown in FIG. 3) for forwarding between the signal plugs 5. In addition, as the conduction terminal 11 for transmitting between the signal plugs 5 is formed integrally (as shown in FIG. 4), it can effectively reduce a distance between the signal plugs 5, and can avoid a problem of signal attenuation caused by transmitting signal in tandem. Accordingly, the signal transmission effect cannot be compared by an existing dual-slot connector formed by a plurality of conduction terminals.

Accordingly, the present invention of fixing device of a communication socket can increase an accurate connection between a signal plug and the socket to assure a clear and stable signal during transmitting, and can reduce a number of transmissions and a transmission distance between the signal plugs to avoid an attenuation of the signal.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A fixing device of a communication socket comprising primarily a seat made by an insulation material whose center position is provided with a conduction terminal for providing a signal connection; an upper and lower casings which can enclose the aforementioned seat, and form slots for holding signal plugs with the seat; and a stopping piece which is extended to form a flexible holding member for providing a clipping force to the slots.

2. The fixing device of a communication socket according to claim 1, wherein two ends of the seat are extended upward and downward respectively, and the corresponding slots are formed on the upper and lower casings.

3. The fixing device of a communication socket according to claim 1, wherein the conduction terminal is located at a center position of the seat, and is extended toward two ends to form a corresponding free end.
